(19) United States
(12) Patent Application Publication
(10) Pub. No.: US 2010/0184609 A1
(43) Pub. Date: Jul. 22, 2010

(54) USE OF A TERNARY MATRIX AS AN ADAPTER FOR MOLECULAR BIOLOGICAL INFORMATION, AND A METHOD TO SEARCH AND TO VISUALIZE MOLECULAR BIOLOGICAL INFORMATION STORED IN AT LEAST ONE DATABASE

(75) Inventors: Fabio Passetti, Rio De Janeiro (BR); Paulo Sergio Lopes De Oliveira, Sao Paulo (BR); Jeryes Farah, Sao Paulo (BR); Victor Senos Dobroff, Sao Paulo (BR); Marcelo Garcia, Rio De Janeiro (BR); Carlos Alberto de Braganca Pereira, Sao Paulo (BR); Francisco Elói Soares De Araújo, Sao Paulo (BR); Carlos Gil Moreira Ferreira, Rio De Janeiro (BR)

Correspondence Address: THE NATH LAW GROUP, 112 South West Street, Alexandria, VA, 22314, US

(73) Assignees: FUNDAÇÃO DE AMPARO Á PESQUISA DO ESTADO DE SÃO PÃO PAULO- FAPESP, São Paulo-SP (BR); FUNDAÇÃO ARY FRAUZINO PARA PESQUISA E CONTROLE DO CÂNCER, Rio De Janeiro- RJ (BR); FUNDAÇÃO ZERBINI, São Paulo-SP (BR); Fabio PASSETTI, Rio De Janeiro-RJ (BR); Paulo Sergio Lopes DE OLIVEIRA, São Paulo-SP (BR)

(21) Appl. No.: 12/451,479

(22) PCT Filed: May 14, 2008
(86) PCT No.: PCT/BR2008/000140

§ 371 Date: Feb. 24, 2010

(30) Foreign Application Priority Data
May 15, 2007 (BR) PI0703888-7

(51) Int. Cl. C40B 30/02; C40B 40/00

(52) U.S. Cl. 506/8; 506/13

(57) ABSTRACT

It is proposed by the present invention the use of ternary matrices as an adapter of molecular biological information for integration of the said biological information. Another exclusive aspect of the present invention consists in a method of search and visualization of molecular biological information stored in at least one database, wherein a preferred implementation of the method is made using a computer program and wherein the same may be accessed using a computer network such as the Internet.

### FIELD OF THE INVENTION

The present invention is related to the fields of molecular biology, biophysics, and more specifically, bioinformatics. More particularly, the present invention is related to the identification of molecular candidates for diagnosis and prognosis of pathologies by means of the use of molecular biological information adapted by ternary matrices.

### PRIOR ART

### Collections of Information on Gene Architecture

The conclusion of the sequencing of the human genome and of other species has made possible more comprehensive studies on the expression, the architecture and the genic distribution. The exponential growth of the deposits of sequences derived from sequencing projects in public databases has enabled unprecedented studies. Other types of public collections of biological data, such as, for example, of proteins and promoters, do not evidence such accelerated growth. However, the increasing accumulation of these types of information in the last decades was of the order of hundreds of times. In this regard, bioinformatics arose as an important multidisciplinary field that deals with a large amount of information. Table 1 shows some of the main research entities that host important public collections of biological data.

TABLE 1
Main research entities that have public
databases of biological information.

| | | TYPE OF BIOLOGICAL |
|---|---|---|
| ENTITY | COUNTRY | DATA STORED |
| National Center | United States | Deoxyribonucleic acid, |
| for Biotechnology | of America | ribonucleic acid and |
| Information | | polypeptide chain |
| University of | United States | Deoxyribonucleic acid, |
| California | of America | nucleic acid and |
| Santa Cruz | | polypeptide chain |
| The Institute for | United Kingdom | Deoxyribonucleic acid, |
| Genomic Research | | nucleic acid and |
| | | polypeptide chain |
| Swiss Institute of | Switzerland | Deoxyribonucleic acid, |
| Bioinformatics | | nucleic acid and |
| | | polypeptide chain |
| Protein Data Bank | United States | polypeptide chain |
| | of America | |

This enormous amount of data is spread throughout several collections. The researches particularly conducted in the field of molecular biology quite often require the integration of such data, originating from different collections.

In fact, the convergence of information related to a gene may be extremely useful, both for still new large-scale studies and for case-specific analysis of genes of particular interest. There are presently some approaches related to the gathering of biological data of genes of an organism and the availability of graphic viewers that aid in the observation of such information (Table 2).

TABLE 2
Main freely accessible gene portals.

| APPLICATION NAME | INTERNET WEBSITE ADDRESS |
|---|---|
| NCBI Entrez Gene | http://www.ncbi.nlm.nih.gov/entrez/ |
| | query.fcgi?db=gene&cmd=search&term= |
| NCBI MapViewer | http://www.ncbi.nlm.nih.gov/mapview/ |
| | map_search.cgi?taxid=9606 |
| UCSC Genome Browser | http://genome.ucsc.edu/cgi-bin/hgGateway |
| UCSC Proteome Browser | http://genome.ucsc.edu/cgi-bin/pbGateway |
| Ensemble Genome Browser | http://www.ensembl.org/index.html |

The proposal of the National Center for Biotechnology Information (NCBI), of the United States of America, consisted in the creation of the database Entrez Gene (MAGLOTT at al., 2005), wherein genetic information may be viewed using, as a basis, sequences of genes and genomes from the RefSeq project (PRUITT; TATUSOVA; MAGLOTT, 2005). One other approach was developed at the European Bioinformatics Institute (EBI), with the database Genome Reviews and its Internet portal Integr8, for visualization of this data (KERSEY et al., 2005). Finally, there is still a third alternative hosted at the University of California Santa Cruz Genome Bioinformatics (KAROLCHIK et al., 2003), wherein there is a special viewer intended for analysis of proteins, the UCSC Proteome Browser (HSU et al. 2005), and another one for transcriptional data, the UCSC Genome Browser. Thereby, the information on proteins, transcripts and the expression profile of genes of various organisms can be studied with the aid of various databases, but with the inconvenience of having no integration between them.

However, the Applicant, unprecedentedly and surprisingly, discloses herein the use of a data adapter that integrates each and every biological data mapped in a sequenced DNA region, viewed in at least one database, something not previously presented in the approaches described above.

To this end, a methodology based on the alignment of gene transcripts and protein data in a sequenced DNA region of any organism has been developed. By using a data adapter, the ternary matrix, which enables the integration of the said data in at least one database, it is possible to conduct a detailed investigation of a gene, using the benefit of the graphic interface of a viewer, as well as to conduct large-scale analyses of the database.

### Molecular Elements, Molecular Characteristics and Ternary Matrices

For a better understanding of the present invention, two terminologies for generalization of the data will be introduced. Thus, the sequences of deoxyribonucleic acids (DNAs), ribonucleic acids (RNAs) and polypeptide chains (proteins) will be designated as molecular elements, which in turn may have molecular characteristics, these latter being either physical, chemical or biological (Table 3).

TABLE 3
Examples of molecular elements characteristics.

| MOLECULAR | EXAMPLES OF MOLECULAR |
|---|---|
| ELEMENT | CHARACTERISTICS |
| Deoxyribonucleic | SNP [Single Nucleotide Polymorphism], |
| acid (DNA) | mutation, CpG island, haplotype and promoter |
| Ribonucleic | miRNA binding site, polyaldenylation signal, |
| acid (RNA) | alternative splicing events, regulatory site, |
| | secondary structure formation region |
| Polypeptide | Catalytic site, residue of interaction with |
| chain (protein) | other proteins/ligand, phosphorylation site, |
| | glucosylation site, tridimensional structure, |
| | functional domain and structural domain |

By means of the alignment of any of the types of molecular elements described in table 3 against a sequenced region of deoxyribonucleic acid, ternary matrices are produced for each of the molecular elements.

Briefly, the ternary matrices according to the present invention are matrices of size N×M, wherein N is the number of rows, relative to the different molecular elements or characteristics mapped in a given region of sequenced DNA, and M is the number of columns, relative to all the consensus exons and consensus introns of a given gene. A consensus exon is a region between two bases of a known sequenced DNA that is confirmed by more than one transcript mapped to a given gene region. A consensus intron is a region of the gene that is absent in all the transcripts mapped to a given gene region. Each column is assigned a character X, in case of presence, or Y, in case of absence, in a given molecular element or characteristic, of a sequence relative to a biological information of interest aligned with the established consensus exon, or Z to indicate the beginning and the end of a given exon relative to a given molecular element or characteristic, wherein X, Y and Z are different from one another.

In a preferred embodiment of the construction of the matrices in question, X is equal to “1”, Y is equal to “0” and Z is any character other than “1” and “0” when X and Y are thus represented, and is most preferably the character “|”.

Once the ternary matrices for the molecular elements are obtained, all and any chemical, physical or biological molecular characteristics (see the examples in Table 3) of a given molecular element will have a ternary matrix of equal size created as mentioned above. Therefore, by means of a data adapter, the ternary matrix, it is possible to view and to prospect, in small or in large scale, the obtained data.

Approaches that Make Use of Matrices for Genes Analysis

In the scientific literature, there are some approaches that use matrices as adapters of biological data. In order to reach the concept of ternary matrix as a form of data adapter for integration of any element or molecular characteristic of a gene, it was necessary to widen and improve the methodology developed in the master's dissertation of Fabio Passetti (PASSETTI, 2002). In this reference, binary matrices were employed for detection of usage of alternative exons events, which is the most frequent type of alternative splicing events in human transcripts. Alternative splicing is the process whereby various mRNAs from the same primary transcript are produced.

In a similar approach, the binary matrices were also used to study sequences from the Cancer Genome project in Brazil (SAKABE et al., 2003).

Subsequently, this same methodology was used to assist in the analysis of EAU alternative splicing events in all the sequences produced by the large-scale tumor transcripts sequencing projects (BRENTANI et al., 2003).

Finally, it was also used by Kirschbaum-Slager et al. (2005), for detecting the most expressed exons in tumors.

In turn, Nagasaki et al. (2005) published a study wherein binary matrices are produced for each messenger ribonucleic acid (mRNA) entirely or partially sequenced. From this preprocessing, the said authors avail themselves of these matrices for the detection of alternative splicing events and alternative transcription initiation events in six organisms.

In Nagasaki et al. (2005) work, it is presented data related to a study restricted to the universe of two types of cellular events that occur in transcripts, using the data adapter designated as a binary matrix.

The present invention, on the other hand, proposes the use of a ternary matrices system, wherein the character “|” is used for delimiting exons. In a first instance, the use of this character, which renders the matrix used in the instant invention a ternary matrix, enables a fast inspection of the stored transcription data, without requiring a search for position of limits of exons and introns in the matrix.

One other discrepant point from the said prior art resides in the fact that, in an unprecedented and innovative manner, ternary matrices is used for the studying proteins. In this manner, protein information is stored in the instant data adapter.

One other fact that renders the present invention different from that presented by Nagasaki et al. (2005) is the fact that, once again in this case, in an unprecedented and innovative manner, one sole data adapter, the ternary matrix, is used for molecular element characteristics. Therefore, the ternary matrices are used as a sole data adapter capable of integrating data of DNA, RNA, proteins and each and any characteristic that can be mapped in the sequenced DNA region wherein the molecular elements were anchored.

In summary, the use of the ternary matrices according to the present invention differs from the others in three aspects: 1) for using a delimiting character to indicate the beginning and the end of a given exon relative to a certain molecular characteristic or element; 2) for using the ternary matrices for molecular elements and, unprecedentedly and innovatively, for protein data; and 3) for using the ternary matrices, unprecedentedly and innovatively, as the sole adapter of molecular biological information, aiming to integrate molecular characteristics with their molecular elements.

### Use of the Ternary Matrices as a Form of Graphic Representation in a Viewer.

The use of the ternary matrices as an adapter of molecular biological information relative to any molecular characteristic or element has not been proposed in the art to date. With this use of the ternary matrix, it has become possible, as will be described in the instant specification, to build a new form of integrating biological data.

The viewing of data of polypeptide chains mapped in a sequenced region of deoxyribonucleic acid also constitutes an important aspect of the present invention.

The Internet portals NCBI Map Viewer and Ensemble Genome Browser present protein data, referring thereto by means of the translation of the available messenger ribonucleic acids. The UCSC Genome Browser does not display protein data in its viewer, and this type of information is presented in a portal built specifically for protein data, the UCSC Proteome Browser.

In light of what has been set forth above, one other important aspect of the present invention consists in a method for searching and viewing the mappings in a region of the sequenced DNA of the molecular elements and their molecular characteristics, as well as of the ternary matrices, by means of an innovative and unprecedented viewer built for this purpose. The said viewer is preferably built into an Internet portal, using the Java platform to build the same. This building aspect constitutes a further aspect of the present invention.

In this viewer it is possible to obtain visual access to transcript and protein data, as well as to important molecular characteristics. In an unprecedented and innovative manner, this viewer displays data of the protein polypeptide sequence with three-dimensional structure defined experimentally by X-ray diffraction, as well as by nuclear magnetic resonance.

One other innovative aspect of the invention is the mode of graphic representation of structural protein domains, in linear manner, which eases the manual inspection of proteins with this type of molecular characteristic.

The present invention presents a form of graphic representation of protein data using the architecture of the exons. There is no information of prior disclosure of graphic representation of functional domains, structural domains and proteins sequences with three-dimensional structures resolved experimentally by using the exon architecture of the genes.

The viewer described herein thus appears as a new proposal for visualization of gene data, by integrating, in at least one database, information on proteins and transcripts, as well as their molecular characteristics.

A New Form of Graphic Representation of Alternative Transcription Product Events.

A further important aspect of the present invention consists in a method for search and visualization of transcriptional variants arising from alternative splicing events. Differently from the other portals built specifically for viewing genes containing evidences of these post-transcriptional events, the viewer according to the present invention proposes an innovative and unprecedented form of representation and grouping of transcripts of one same transcriptional variant by means of the use of the ternary matrices. There are some specific databases for the study of alternative splicing events, but none of those provides a combination with protein data (Table 4).

TABLE 4
Main gene information portals comprising
alternative splicing events.

| APPLICATION NAME | INTERNET WEBSITE ADDRESS |
|---|---|
| Alternative Splicing | http://www.bioinformatics.ucla.edu/ASAP2/ |
| Annotation Project | |
| Alternative Splicing and | http://alterna.cbrc.jp/ |
| Transcription Archives | |

Finally, it should be pointed out that the citation of any references in the instant specification should be deemed to constitute an admission that such reference is available as “prior art” with regard to the instant patent application.

### OBJECT OF THE INVENTION

The present invention provides the use of ternary matrices as an adapter of molecular biological information, intended to integrate this information. Furthermore, the invention also provides a method to view and search, in an integrated manner, molecular biological information stored in at least one database.

The invention therefore solves the problem found in the prior art, since there was not any approach available to integrate the different genomic, transcriptional and protein data, by means of the use of ternary matrices, nor there was a method to search and view in an integrated manner said information in one viewer, for proper and fast identification of molecular candidates for diagnosis and prognosis of pathologies.

### BRIEF DESCRIPTION OF THE INVENTION AND OF THE FIGURES

The present invention proposes the use of ternary matrices to constitute an adapter means for molecular biological information in order to integrate said biological information.

The present invention further proposes an exclusive method of search and visualization of molecular biological information stored in at least one database, wherein the method is preferably implemented by means of a computer program and wherein the access is made through a computer network such as the Internet.

FIG. 1 shows the correlation between molecular elements aligned with a DNA region and their respective ternary matrices.

FIG. 2 represents an enlarged version of FIG. 1, with molecular characteristics data inserted therein.

FIG. 3 shows the alignment between a protein sequence produced by a mRNA with 3 exons and a sequence of a three-dimensional protein structure.

FIG. 4 corresponds to the comparative graphic representation of the methodology according to the present invention and that of Nagasaki et al. (2005) using three distinct hypothetical molecular elements.

FIG. 5 represents the initial screen of the viewer according to the present invention.

FIG. 6 shows the initial screen of the viewer according to the present invention, using as a keyword, for example “APOE”, for searching by gene symbol.

FIG. 7 represents the result screen upon using the keyword, for example, “APOE”, for searching by gene symbol.

FIG. 8 shows the initial screen of the viewer according to the present invention, using as a keyword, for example, “CN277391”, for searching by identifier.

FIG. 9 illustrates, as an example, the operation of the approximation tool.

FIG. 10 illustrates, as an example, the operation of the ruler in the viewer according to the invention.

### DETAILED DESCRIPTION OF THE INVENTION AND OF THE FIGURES

### Use of the Ternary Matrices

The present invention is based on the presupposition that all the molecular characteristics and elements available at that given time have been aligned to a sequenced region of deoxyribonucleic acid (DNA).

The alignment is a form of placing the sequenced region of deoxyribonucleic acid over all the molecular characteristics and elements available at that given time, in order to obtain a correspondence.

One such molecular element according to the present invention comprises the sequence of a deoxyribonucleic acid (DNA) molecule, a ribonucleic acid (RNA) molecule or polypeptide chain (protein) determined experimentally or by prediction. One such transcript is a sequence of a ribonucleic acid (RNA) molecule, or a sequence of a complementary deoxyribonucleic acid (cDNA) molecule. One such protein is a sequence of a polypeptide chain.

One such molecular characteristic according to the present invention comprises any physical, chemical or biological characteristic or property that a molecular element possesses or that has been predicted to be possessed thereby.

In a broad sense, the present invention extends to encompass a ternary matrix applicable to any molecular element or its characteristic that is mapped in a sequenced region of deoxyribonucleic acid.

Ternary matrices are produced by means of the alignment of RNA, complementary DNA (cDNA) or of a polypeptide chain (protein) sequences with a given DNA sequence.

In summary, the obtainment of the ternary matrices may be understood as follows: Upon obtaining all mapping data relative to transcripts and proteins in a given region of DNA, the data is used to create consensual coordinates of the said exons.

In this manner, a ternary matrix for a given molecular element or its characteristic is filled in accordance with the comparison of the mapping coordinates of the molecular element or the molecular characteristic in question with the consensual coordinates.

In order to build the consensual coordinates of the exons, the mapping data is split into regions of exons and a consensus is established for each region. A region of exons is therefore a region formed by sequences relative to biological information of interest in a given different molecular element or characteristic that evidence overlapping within the DNA region.

Upon splitting this portion of the DNA into regions of exons, we start to analyze each region separately. The consensual coordinates of the exons were defined in the following manner: ei represents an initial coordinate of any exon and ef represents a final coordinate of any exon, wherein ei and ef are not coordinates of external exons, and ci and cf are, respectively, the beginning and the end coordinates of one same region of exons. An external exon is one which is at the 5′ and 3′ extremities of the transcript and amino and carboxy-terminals of the proteins, and it is impossible to determine what is before the first exon or after the end of the last exon. For ci≦ei and ef≦cf, we have, for any region of exons, the following valid pairs of coordinates:

(i,j−1), if i=ci and (j=ei or j=ef);

(i,j−1), if (i=ei or i=ef) and (j=ei or j=ef) ej−i≦20;

(i,j), if i=ci and j=cj;

The coordinates of external exons were used for the production of the consensus when pi=ci and pf=cf, wherein pi represents an initial external coordinate of any molecular element and pf represents a final external coordinate of any molecular element, and ci and cf represent, respectively, the beginning and the end coordinates of one same region of exons.

Based on the definition of the consensual coordinates, we define a matrix C of size N×M, wherein N is the number of rows relative to the different molecular elements or characteristics mapped in a given region of sequenced DNA, and M is the number of columns, relative to all consensus exons and consensus introns of a given gene.

The matrix is then filled in the following manner: It is defined that c((i_{I},j_{I}), . . . , (i_{M},j_{M})) is the set of pairs of consensual coordinates of the given region of DNA, wherein M is the number of pairs of coordinates. In the said matrix, M represents all the consensus exons and introns with the addition of two control elements, one placed at the beginning and the other at the end of the vector, there being preferably designated by the character “|”, to aid in the reading of the vector-line by other softwares. One element c(iₖ, jₖ) may have preferentially “1” attributed thereto when such consensus exon coordinates are found, preferably “0” when the same are absent or preferably “|” when the said region comprises an intron.

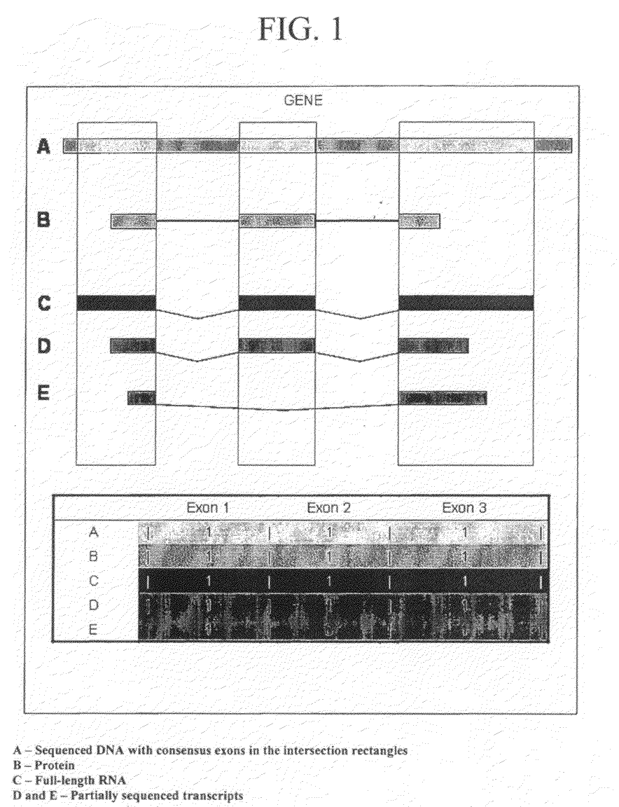

In FIG. 1, which refers to the exemplary correlation between molecular elements aligned with a DNA region and their respective ternary matrices, it is shown a hypothetical gene comprising mapped molecular elements (wherein A is the sequenced DNA itself with consensus exons in the intersection rectangles; B is the protein, C is complete RNA; and D and E are partially sequenced transcripts) and their respective ternary matrices. In all the regions wherein there is the creation of a ternary matrix, the very deoxyribonucleic acid used as an anchor for the alignments becomes a molecular element that comprises all the consensus exon regions marked, for example, with “1”, according to the preferred form described above.

Using the definitions of the ternary matrices of all the molecular elements of a given sequenced region of DNA, information intended to increase the amount of data gathered in specific databases is searched.

Thereby, once the ternary matrices are built for each molecular element, all of the molecular characteristics thereof are then transformed into ternary matrices.

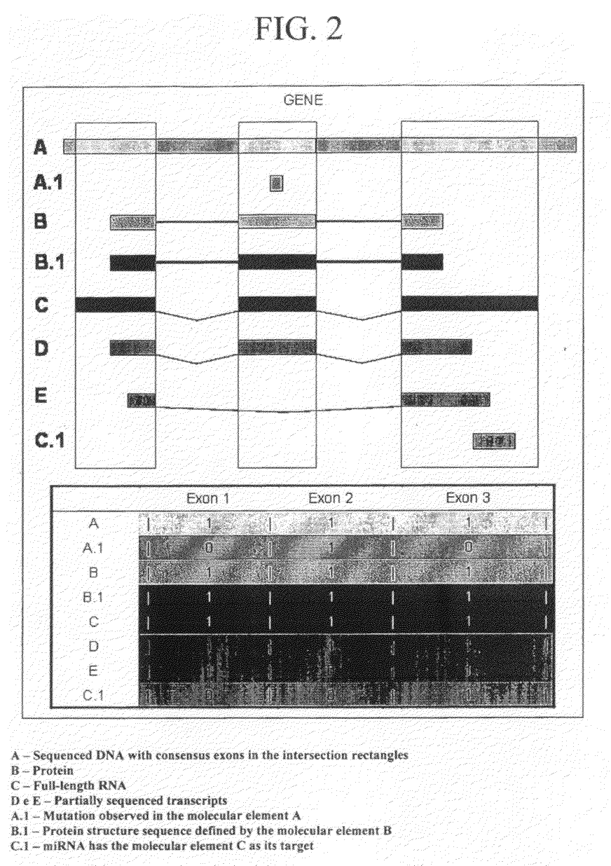

FIG. 2 provides an exemplary representation of the addition of molecular characteristics relative to a mutation observed in molecular element A (A.1), the sequence of the protein structure defined by the molecular element B (B.1) and the microRNA (miRNA) that targets the molecular element C (C.1). There will be described in the following the insertions, into the ternary matrices, of said hypothetical molecular characteristics.

In the case of the molecular characteristic of mutation in DNA, shown graphically in FIG. 2, under the designation A.1, the steps to be followed consist simply in searching the coordinate of the mutation in the sequenced region in question and pose the question of whether this mutation is present in the region of consensus exons. Since the mutation is present, a ternary matrix was created for the same. In terms of coordinates, only for this hypothetic example, if the mutation is in position 125 of the DNA sequence used as an anchor to align the remaining molecular elements, and there is an exon consensus defined between positions 100 and 150 of the said DNA sequence, the ternary matrix for this mutation will evidence, for example, only a “1” for this position, and the remaining ones that do not contain the character “|” will be filled, for example, with “0”.

For the case of the molecular characteristic of protein structure, shown graphically in FIG. 2, under the designation B.1, the steps to be taken consist merely in firstly defining which amino acids of protein B are present in each position of the ternary matrix. Having done so, there is attempted to pass the information of alignment between the sequence of the protein and the sequence of the protein structure to correlate the amino acids, and thereby correctly attribute the “0” and “1” at the correct positions. In terms of coordinates, only for this hypothetic example, if the sequence of the protein structure is identical for all the amino acids of the protein A, the ternary matrix for this protein structure will evidence “1” in the same positions of the ternary matrix of the protein A, as well as for eventual occurrences of “0”.

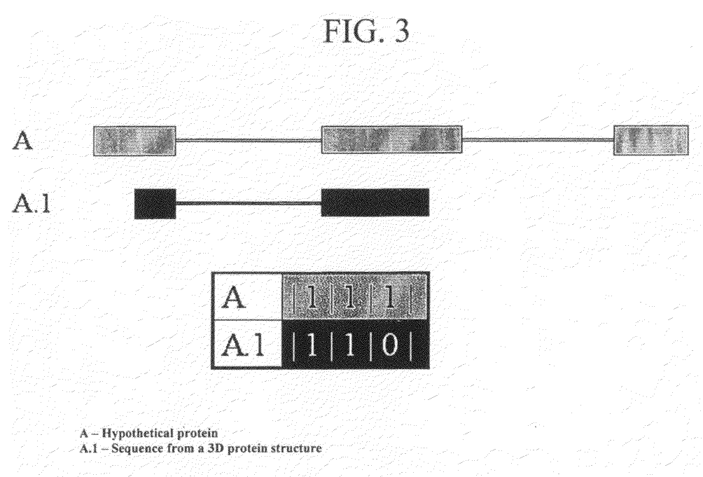

In cases of partial alignment, for example, of the sequence of a protein structure, it should be borne in mind that if there is an overlapping of an amino acid as a result of the reference sequence of a protein whereto was attributed “1” in the ternary matrix thereof, this molecular characteristic will also receive the same attribution (FIG. 3). FIG. 3 represents, as an example, a hypothetical protein A produced by an mRNA of 3 exons and the alignment of a sequence of a three-dimensional protein structure (A.1) defined experimentally.

Generally speaking, a sequence relative to a given biological information in a given molecular element or characteristic partially aligned with the established consensus exon is sufficient to determine the presence thereof in the data adaptation.

Finally, for the case of the molecular characteristic of microRNA (miRNA), shown graphically in FIG. 2, under the designation C.1, the steps that should be taken simply consist in searching the coordinate targeted in the mRNA produced and mapping these coordinates in the matrix built for the mRNA. As shown in FIG. 2, the miRNA target is the third exon of the gene that encodes the mRNA in question. In this manner, the ternary matrix built for this specific miRNA would be filled with “1” only in the last exon.

Therefore, for the present invention, the insertion of the molecular characteristics of a given molecular element in a ternary matrix system is provided, firstly, by the fact that the mapping of the molecular characteristic in the sequence of the molecular element necessarily occurs. Subsequently, these coordinates of the molecular characteristic are translated into a ternary matrix, using the ternary matrix initially produced for the molecular element in question.

As already described above, the utilization of matrices as a data adapter was used by Nagasaki et al. (2005), who show in their study a large-scale analysis, wherein binary matrices are produced for each completely or partially sequenced mRNA. The authors used those matrices for detecting alternative splicing events and alternative transcription initiation in six organisms.

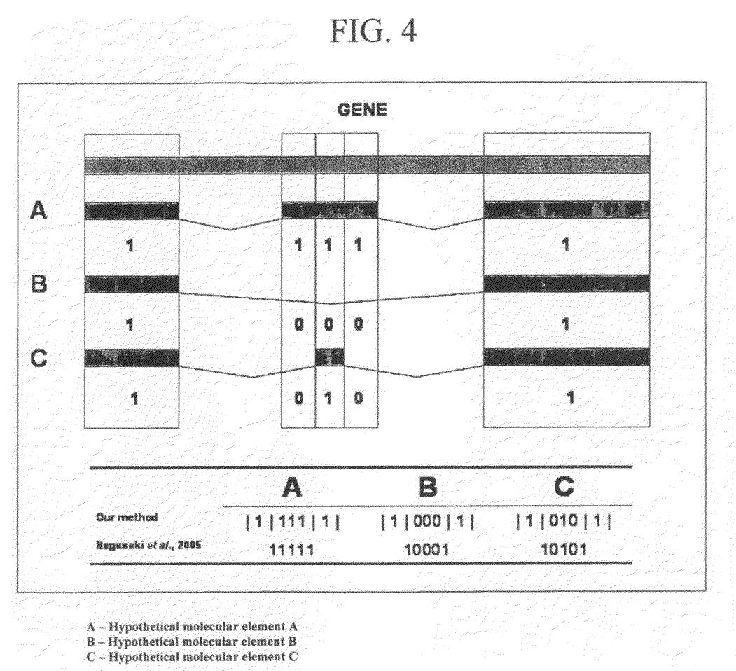

FIG. 4 presents a comparative graphic representation of the methodology employed in the present invention and that disclosed by Nagasaki et al. (2005) for a hypothetical gene with three alternative splicing isoforms. However, according to the present invention, the designation “A” in FIG. 4 may be a transcript, a protein or a molecular characteristic of any of such isoforms. To Nagasaki et al. (2005), the said designation will always be related to a transcript and never to a characteristic thereof.

The first of the differences between the present invention and that of Nagasaki et al. (2005) resides in the fact that the present invention uses a delimiting character to separate the exons relative to a given molecular element or characteristic, wherein the character is other than “0” or “1” when the other data is thus represented, and is preferably represented by the character “|”. This accelerates and simplifies the large-scale analysis of the genes, since it does not require post-processing of the matrices to locate the said limits.

One other point of discrepancy between the present invention and the work of Nagasaki et al. (2005) resides in the fact that the present invention incorporates data from mapping of sequences of polypeptide chains and qualities of ribonucleic acids (RNA), of complementary deoxyribonucleic acids (cDNA), of deoxyribonucleic acids (DNA) and of polypeptide chains.

Therefore, the data adapter disclosed in the present invention is quite different from that used by Nagasaki et al. (2005), since there is extrapolated the concept of data adapter only for detection of alternative splicing and starting events, to the integration of biological data which have been mapped in a sequenced DNA region.

The hypothetical data cited herein is merely illustrative and intended to provide a better understanding of the building of ternary matrices of molecular elements and characteristics, and should not be construed as restricting the scope of the present invention.

The Method for Search and Visualization of Molecular Biological Information

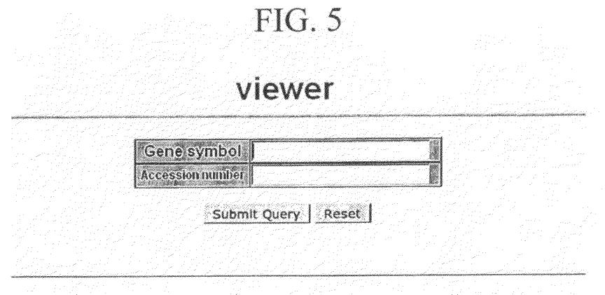

One other aspect of the present invention, as illustrated in FIGS. 5 to 10 and Tables 9 to 18, consists in a method for search and visualization of molecular biological information stored in at least one database, the method being preferably implemented by means of a computer program.

The method comprises the following steps:

(i) displaying to the user a field for inputting the biological information to be searched;

(ii) input by the user, in the field displayed in step (i), of the biological information to be searched;

(iii) reading of the biological information integrated in a ternary matrix used as an adapter of molecular biological information as previously defined and of supplementary biological information, in accordance with the search requested in step (ii);

(iv) generation of text and graphic representations of the information read in step (iii), where the graphic representations may have distinct colors in order to evidence the source of each biological information;

(v) generation of a plurality of panels containing the representations generated in step (iv), wherein the panels may have the same horizontal scale that is based on the transformation of genomic coordinates of the biological elements according to the screen wherein the panels will be displayed; and

(vi) displaying to a user, on the screen of a display device, preferably a computer monitor, the plurality of panels generated in step (v).

The panels generated in step (v) may represent small molecular characteristics, consensus of the exons, protein and transcripts.

In order to provide an easy understanding to the user of the information displayed in the panels, the latter may be displayed in alignment with one another to occupy harmoniously the entire screen whereon they are displayed. Furthermore, the heights of the panels may be adjusted automatically in order to accommodate the amount of information to be displayed, and in this regard the heights and/or the widths of the panels may be adjusted by the user for purposes of providing the best possible visual comfort.

Optionally, prior to step (i) of the method, there may be included the step of displaying a field intended for input of the user identification, to allow access to the user if the same is registered at the database. In addition to the identification of the user, there may exist a field for input of the security password of the user, to allow access to the user if the password typed by the user coincides with that which is stored in the database.

The graphic representation of the biological elements displayed in at least one of the panels may comprise graphic elements to identify the initial and final genomic coordinates of the biological element that constitutes the object of the search.

In the preferred embodiment of the method according to the present invention, there is the possibility of user interaction with the information displayed onscreen, where such interaction may be provided by means of a computer mouse or similar device allowing to select the displayed areas. Upon selecting regions of the elements displayed in the panels, the user will be able to visualize the biological information integrated in the ternary matrix as previously defined and the supplementary biological information, such as for example, organs of expression. The visualization of the biological information may be provided by means of a window displayed on the screen of the display device, as depicted in Table 17.

In the preferred embodiment of the present invention, the method is accessed by the user through the Internet and/or through a local computer network.

A more detailed description of the preferred embodiment of the present invention is provided below, implemented by means of a computer program. Since the method is intended for purposes of search and visualization of information, the term viewer is used throughout the present text to identify the method.

The graphical viewer interface receives as a running parameter the path wherein were created the files comprising the information on small molecular characteristics, consensus exons, proteins and transcripts related to the gene pointed out by the user.

The files are searched and read, record by record, and are stored in the memory, in instances of the four classes of data of the program (small molecular characteristics, consensus exons, proteins and transcripts).

Each record of small molecular characteristics, proteins and transcripts contains the information of the ternary matrix of its equivalence with the consensus. The information of the matrix is stored as an attribute of the created project, either of small molecular characteristics, proteins or transcripts.

The program creates a screen, which preferentially includes four panels that will accommodate the text and graphic representations of the data to be displayed. The said panels may be of equal width and may be placed over one another, in the following order: Small molecular characteristics, consensus exons, proteins and transcripts.

The height of the panels may be adjusted automatically according to the amount of information displayed in each one and according to certain criteria in order to provide the best possible comfort to the user. Yet, the user may also freely adjust the height of the panels for protein and transcripts.

The left side of the panels for proteins and transcripts is reserved for the textual identification of the protein, transcripts or their molecular characteristics as drawn at the right thereof. These panels have multiple lines and include a scroll bar for the case where the number of records displayed exceeds the size of the panel.

All the panels follow an equal horizontal scale, which is based on the transformation of the genomic coordinates of the small molecular characteristics, consensus exons, proteins and transcripts into the size of the screen.

The graphical representation of small molecular characteristics, consensus exons, proteins and transcripts is preferably provided by means of small rectangles, filled from the initial genomic coordinate to the final genomic coordinate of the drawn datum.

In the case of the protein panel, the elements represent parts of the proteins aligned along a horizontal line with the coordinates of the corresponding exons in the mapped DNA.

Each line represents a distinct record of the protein, and it is colored in order to evidence its source. Preferably, they are colored as follows: Blue: structures of proteins; Green: domains of proteins structures; Grey: reference-sequences of proteins; and yellow: proteins functional domains.

The system may then initiate a state of standby awaiting commands from the user, by means of the mouse or similar input device. The possible commands are various. Merely as an example, below is described one related to the display of the ternary matrix.

Upon the user clicking with the right button of the mouse or similar input device on one element in the panel of proteins or transcripts, the program will perform the following actions:
Opens a small window near the click-selected element, for display of information related to the protein/transcript;
Displays, in this window, a list with the initial and final coordinates (relative to the sequenced DNA used as an anchor for mapping the molecular elements and characteristics) of all the elements belonging to that record of protein or transcript, as well as the elements identity percentage with regard to the DNA sequence;
Enhances, in bold display mode, preferably in red color, the line that corresponds to the element that was click-selected; and
Redesigns the consensus panel.

The redesigning of the consensus panel is performed in order to substitute, exemplarily, the simple rectangles by, for example, rectangles containing the information bits of the ternary matrix relative to the said protein or transcript. If the consensus exon is present in the protein or transcript, its corresponding rectangle will contain, for example, the character “1”, drawn preferably at the center thereof, in white over black. Otherwise, the rectangle will contain, for example, the digit “0”, drawn preferably at the center thereof, in white over grey.

The same process described above is also valid for elements selected by clicking on the panel of molecular elements.

The program then resumes the standby cycle to await further commands.

The Internet portal comprising the viewer according to the present invention, for visualization of the data integrated by the ternary matrices, was implemented using the JAVA technology. It is necessary that the computer of the final user have installed therein the most recent version of the application Java Runtime Environment (JRE), which may be downloaded free of charge from the website http://www.java.com. The viewer uses as input data four types of files written in GFF format (http://www.sanger.ac.uk/Software/formats/GFF/GFF_Spec.shtml). There will be presented in the following some examples of input data for the files relative to the human gene apolipoprotein E (gene symbol APOE).

The first file, which comprises data of small molecular characteristics, such as for example, prediction data of signal peptides or transmembrane domains, is named smallfeaturesdata.gff. In Table 5 there is presented the example of a hypothetical smallfeaturesdata.gff file.

One other file of input data is named consensusdata.gff, and in this file there should be presented consensus exons coordinates data, using the concept previously defined in the instant specification. One example of a consensusdata.gff file is given in Table 6.

The third file required for the correct operation of the present invention is the file named proteindata.gff. If available, there is provided therein the data of coordinates used for mapping proteins in the said DNA region. In Table 7 there is provided a hypothetical example of the proteindata.gff file.

Finally, the last file required for the complete visualization of the hypothetical gene data is the file mrnadata.gff. In this file there is provided the mapping data of transcripts in the said DNA region. One example of the file mrnadata.gff is given in Table 8.

TABLE 5

| | | | | | | | Reading |
|---|---|---|---|---|---|---|---|
| Identifier | Source | Characteristic | Beginning | End | Identification | Orientation | phase |
| SignalPeptide\|NP_000032 | GENEWISE | similarity | 6 | 14 | 100 | + | • |
| SignalPeptide\|NP_000032 | GENEWISE | similarity | 15 | 18 | 100 | + | • |

| | Supplementary | Sequenced | | |
|---|---|---|---|---|
| Identifier | data | region of DNA | Beginning | End and matrix |
| SignalPeptide\|NP_000032 | Align | NT_011109 | 17678115 | 17678142; Matrix \| 00 \| 1 \| 10 \| 0000 \| |
| SignalPeptide\|NP_000032 | Align | NT_011109 | 17679235 | 17679247; Matrix \| 00 \| 1 \| 10 \| 0000 \| |

TABLE 6

| | | | | | | | Reading |
|---|---|---|---|---|---|---|---|
| Identifier | Source | Characteristic | Beginning | End | Identification | Orientation | phase |
| APOE | Matrix | consensus_exon | 17677166 | 17677316 | • | | • |
| APOE | Matrix | consensus_exon | 17677317 | 17677398 | • | | • |
| APOE | Matrix | consensus_exon | 17678077 | 17678142 | • | | • |
| APOE | Matrix | consensus_exon | 17679235 | 17679260 | • | | • |
| APOE | Matrix | consensus_exon | 17679261 | 17679427 | • | | • |
| APOE | Matrix | consensus_exon | 17680008 | 17680068 | • | | • |
| APOE | Matrix | consensus_exon | 17680069 | 17680493 | • | | • |
| APOE | Matrix | consensus_exon | 17680494 | 17680530 | • | | • |
| APOE | Matrix | consensus_exon | 17680531 | 17680867 | • | | • |

TABLE 7

| | | | | | | | Reading | Supplementary |
|---|---|---|---|---|---|---|---|---|
| Identifier | Source | Characteristic | Beginning | End | Identification | Orientation | phase | data |
| NP_000032 | GENEWISE | similarity | 1 | 14 | 100 | + | • | Align |
| NP_000032 | GENEWISE | similarity | 15 | 78 | 100 | + | • | Align |
| NP_000032 | GENEWISE | similarity | 79 | 317 | 100 | + | • | Align |

| | Sequenced | | |
|---|---|---|---|
| Identifier | region of DNA | Beginning | End, Tissue of expression, Matrix and annotation |
| NP_000032 | NT_011109 | 17678100 | 17678142; Tissue not available; Matrix \| 00 \| |
| | | | 1 \| 11 \| 1111 \|; Annotation NP_000032 |
| NP_000032 | NT_011109 | 11679235 | 17679427; Tissue not available; Matrix \| 00 \| |
| | | | 1 \| 11 \| 1111 \|; Annotation NP_000032 |
| NP_000032 | NT_011109 | 17680008 | 17680722; Tissue not available; Matrix \| 00 \| |
| | | | 1 \| 11 \| 1111 \|; Annotation NP_000032 |

TABLE 8

| | | | | | | | Reading | Supplementary |
|---|---|---|---|---|---|---|---|---|
| Identifier | Source | Characteristic | Beginning | End | Identification | Orientation | phase | data |
| NM_000041 | SIM4 | similarity | 1 | 60 | 100 | + | • | Align |
| NM_000041 | SIM4 | similarity | 61 | 126 | 100 | + | • | Align |
| NM_000041 | SIM4 | similarity | 127 | 319 | 100 | + | • | Align |
| NM_000041 | SIM4 | similarity | 320 | 1179 | 100 | + | • | Align |

| | Sequenced | | End, Tissue of expression, |
|---|---|---|---|
| Identifier | region of DNA | Beginning | Splicing variant and Matrix |
| NM_000041 | NT_011109 | 17677257 | 17677316; Tissue not available; Variant 1; |
| | | | Matrix \| 10 \| 1 \| 11 \| 1111 \|; |
| NM_000041 | NT_011109 | 17678077 | 17678142; Tissue not available; Variant 1; |
| | | | Matrix \| 10 \| 1 \| 11 \| 1111 \|; |
| NM_000041 | NT_011109 | 17679235 | 17679427; Tissue not available; Variant 1; |
| | | | Matrix \| 10 \| 1 \| 11 \| 1111 \|; |
| NM_000041 | NT_011109 | 17680008 | 17680867; Tissue not available; Variant 1; |
| | | | Matrix \| 10 \| 1 \| 11 \| 1111 \|; |

The Internet portal containing the viewer according to the invention may be accessed via the Internet address http://bigviewer.inca.gov.br. For the purposes of the patent application of the present invention, there is a requirement of input of username and password. FIG. 5 depicts the first page of the viewer according to the present invention.

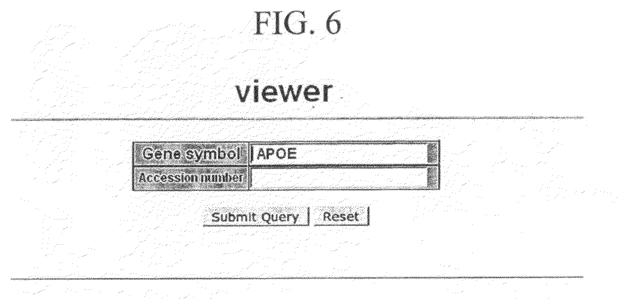

The user may search either by the gene symbol of the gene of interest, or by the access number of molecular elements and characteristics. As an example for the present patent application, FIG. 6 shows the use of the gene symbol APOE, relative to the human gene “apolipoprotein E”.

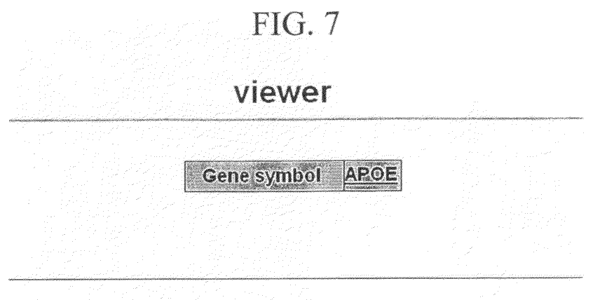

Upon pressing the button “Enviar dados” [“Send data”], the end user will be taken to a result screen, in order that, in case of doubt, the same may select the gene intended to be viewed. FIG. 7 presents, as an example, the result screen of the search conducted on the basis of the search term used in FIG. 6.

Upon left-clicking the mouse or similar device, over the word “APOE”, the user is directed to the graphic visualization page of the data of molecular elements and their characteristics, as well as the matrices thereof.

The viewer according to the present invention comprises five information panels, to wit: information of annotation of the DNA region that is being observed (Panel 1); mapping of the data of small molecular elements and characteristics (Panel 2); data of consensus exons (Panel 3); mapping of molecular elements and characteristics arising from proteins (Panel 4); and mapping of molecular elements and characteristics arising from the transcription (Panel 5).

Panel 1, which is shown exemplarily in Table 9, is preferably displayed with a grey background color and provides the following information: gene symbol, chromosome, identifier of the sequenced region of DNA, direction of the gene and, finally, a link to a help page.

Panel 2, which is represented exemplarily in Table 10, when there is information available, displays the same in the preferred form of small black rectangles. The information displayed in this panel is provided by the file smallfeaturesdata.gff.

Panel 3, which is represented exemplarily in Table 11, displays consensus exon information. Each consensus exon is preferably represented by a grey rectangle. The information displayed in this panel is provided by the file consensusdata.gff.

Panel 4, which is represented exemplarily in Table 12, provides information of molecular elements and characteristics arising from proteins. In Table 12, there is presented, preferably in grey and with the label B, the mapping of the molecular element of protein in question, which in this case is the protein “NP_{—}000032”. Furthermore, preferably in yellow and with the label A, the figure presents the exemplary mapping of the molecular characteristic of functional protein domain of the reference “apolipoprotein A1/A4/E family”. Further, there is presented, preferably in blue color and with the label C, as an example, the mapping of the molecular element of protein sequence with three-dimensional structures defined experimentally under the “1b68_A”, “1ea8_A”, “1gs9_A”, “1h71_A”, “1nfn_{—}”, “1nfo_{—}”, “1or2_A”, “1or3_A”, “1bz4_A”, “1le2_{—}”, “1le4_” and “1lpe_”. Finally, the molecular characteristic of structural protein domains is presented preferably in green color and with the label D, under the exemplary references “four-helical up and down bundle” and “four helix bundle”. The informations displayed in this panel are provided by the file proteindata.gff.

TABLE 9

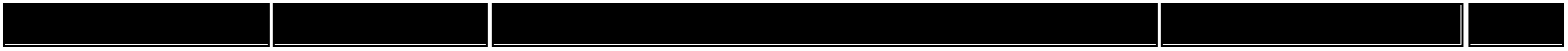

TABLE 10

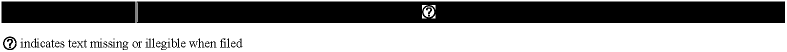

TABLE 11

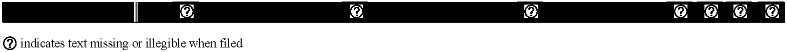

TABLE 12

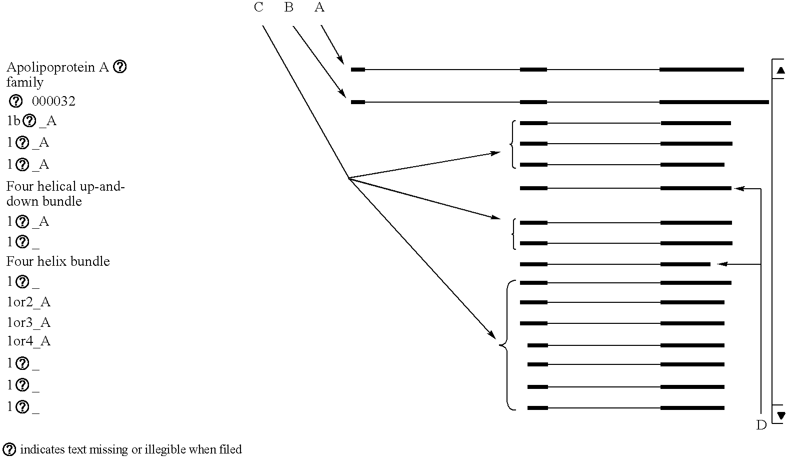

Panel 5 (Table 13) shows, as an example, complete mRNA data (preferably in black and with the label A) and partially sequenced mRNA data (preferably in red color and with the label B). In this panel, if there is any splicing variant defined either by experimentation or computationally, and if such information is correctly input to the file mrnadata.gff, the viewer will be capable, by alternating the background color, preferably between white and grey, of facilitating the visual identification thereof (Table 13a). Therefore, the splicing variants with odd numbers will preferably have a white background color and the ones with even numbers will preferably have a grey background.

The coloring of the molecular elements and characteristics is provided by editing a configuration file named color.properties. A molecular element or its characteristic may be colored using regular expressions. For example, all entries in files containing the pattern “NP_” will be colored in grey, when displayed in the viewer. The configuration should be made using the pattern to be found in the files, in this case “NP_”, followed by the symbol “=” and the color, in English language and in capital letters, as follows: “NP_=GRAY”.

Panels 4 and 5 (Tables 12, 13 and 13a) also present an additional characteristic, which is the visualization, at the left side region thereof, of the identifiers of the molecular elements and characteristics, thereby allowing an easy characterization thereof.

TABLE 13

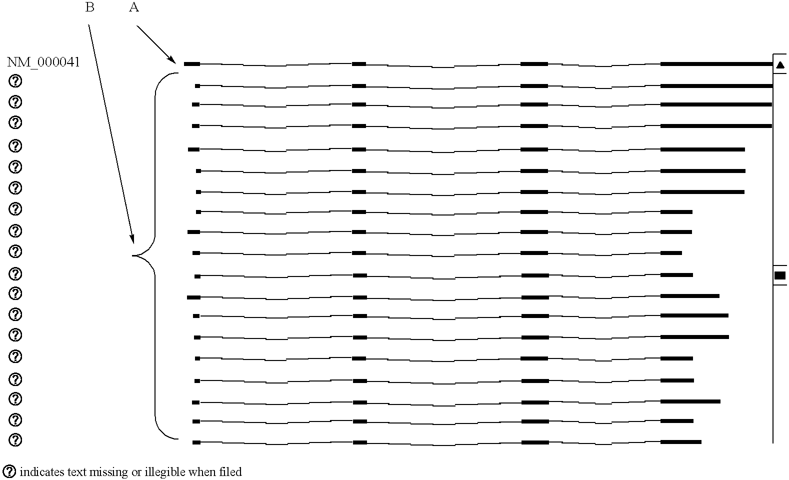

TABLE 13a

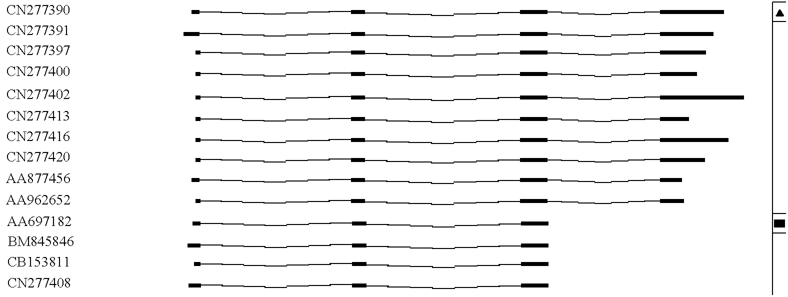

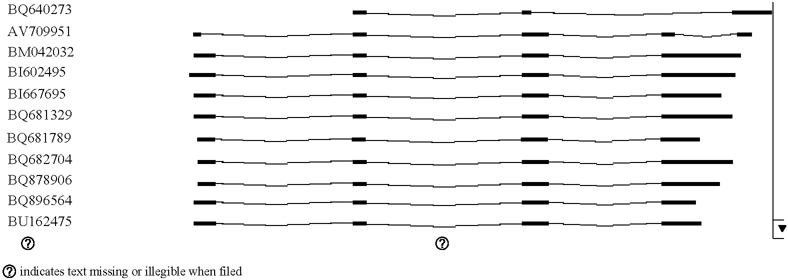

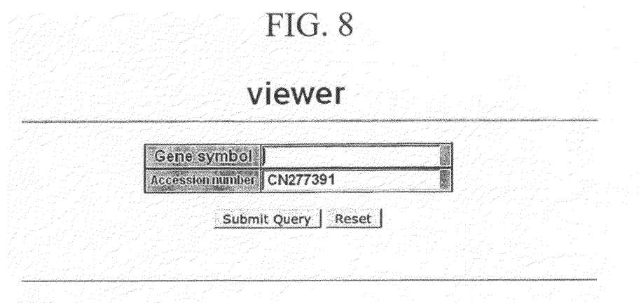

As shown exemplarily in FIG. 6, there is the possibility of the user accessing the data via the identifier of the molecular element or characteristic. In FIG. 8 there is represented the entry screen to the Internet portal containing the viewer, using as a keyword for search by identifier the term “CN277391”.

Table 14 provides a graphic representation of examples of molecular elements related to transcripts and their characteristics for the gene symbol “APOE”. The transcript identified by the access number “CN277391” is preferably displayed in a different color (cyan blue), and it is indicated in the figure with the label A, thereby helping the user to find the desired transcript or protein, since this application operates in panels 4 and 5 of the present invention.

TABLE 14

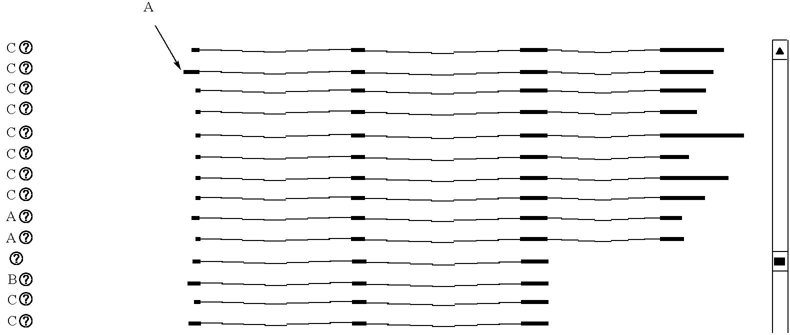

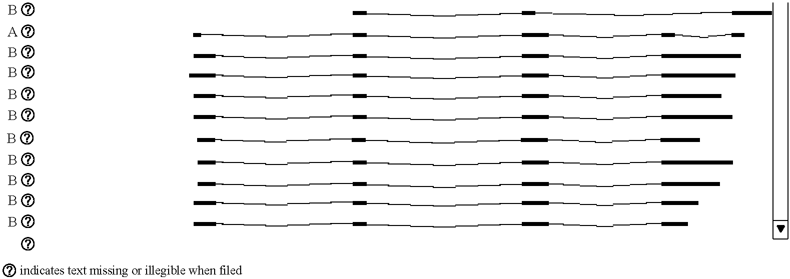

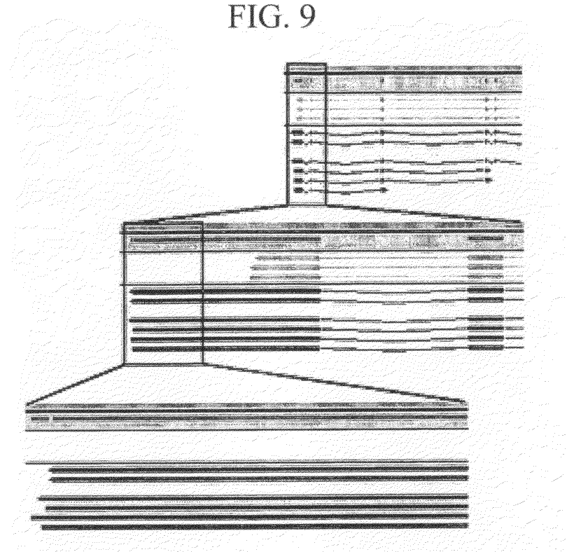

The first characteristic of the viewer according to the invention is the capability of approximating to a region that requires special attention, without the need to reload the information. On pressing the computer keyboard key “Ctrl”, commonly known as the “Control” key, together with the left button of the mouse, or similar device, there is selected the beginning of the region to be approximated. The same will be displayed with a blue line onscreen. By selecting any region to the right of this first selection, and again pressing the computer keyboard key “Ctrl” together with the left button of the mouse or similar device, there is selected the end of the region to be approximated. Thereby, the end user will have the region approximated on the screen of the viewer. At any time, if the end user presses the right button of the mouse or similar device, over any region of the panels not colored with consensus exons or molecular elements and characteristics, there will appear onscreen a written option “Zoom” (enlargement) and, subsequently, “zoom out” (removal of enlargement), for return to the initial visualization mode. In FIG. 9 there is represented, exemplarily, the operation of the approximation tool.

One other characteristic of the instant invention is the selection of the region of a consensus exon. By pressing the left button of the mouse or similar device over the rectangles that characterize a consensus exon in panel 3, there may be observed the selection of a vertical region extending through panels 2, 4 and 5. In Table 15 there is exemplarily shown that the selection of a consensus exon displays the selected region, pointed out by an arrow, in the remaining graphic panels of the viewer.

TABLE 15

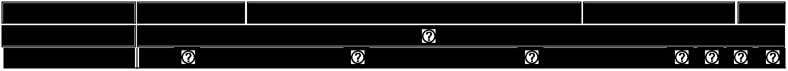

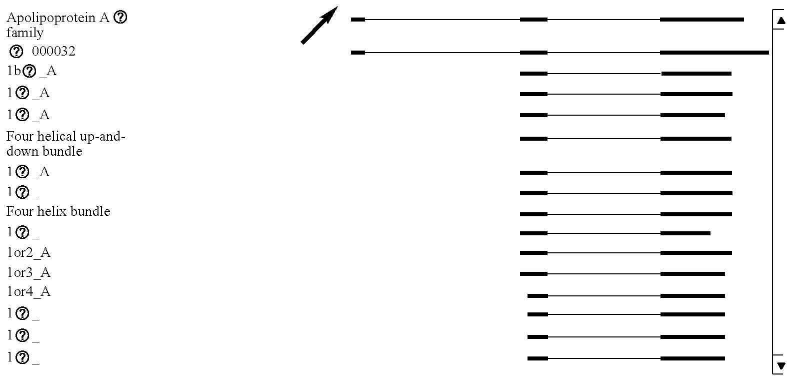

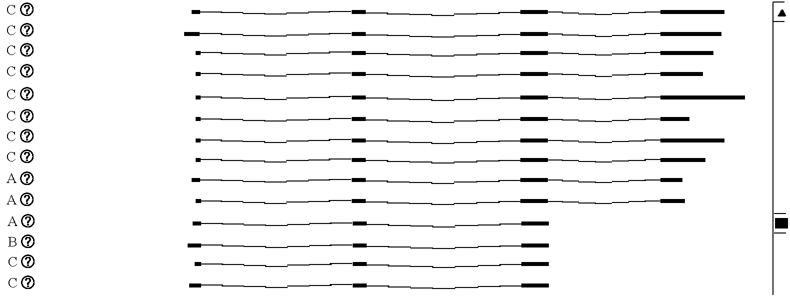

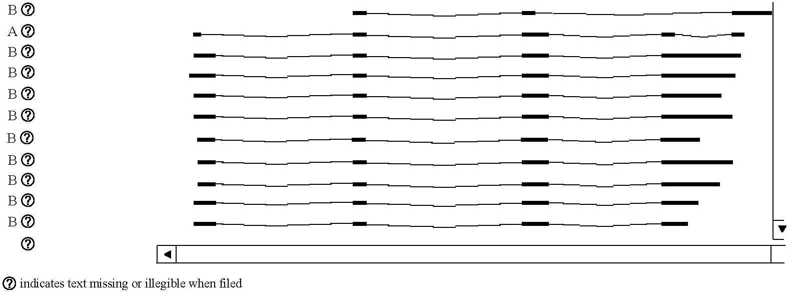

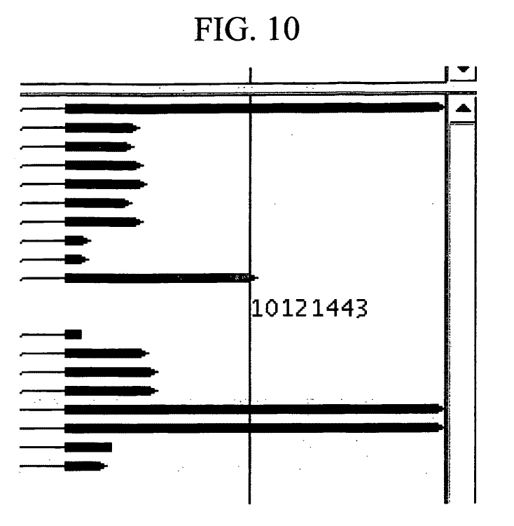

One further aspect of the present invention consists in a ruler that helps the end user to achieve an easier positioning at the sequenced DNA region in question. The said ruler, pointed out exemplarily in FIG. 10, will appear when the left button of the mouse or similar device is pressed over any region of the panels not colored with consensus exons or molecular elements and characteristics. Upon releasing the left button of the mouse or similar device, there will remain drawn in all the panels a vertical line, preferably black, and the numbering relative to the positioning on the sequenced region of the DNA. In order to undo the drawing, the end user must again press the left button of the mouse or similar device, and while keeping the said button pressed, move the mouse or similar device along some distance. Upon the button being released, the ruler will disappear.

An additional aspect of the present invention consists in the horizontal coloring of the panel background, preferably in yellow color, when a molecular element or its characteristic is selected, by pressing the right button of the mouse or similar device over that element or characteristic. At that time, in addition to the altered background color, in order to highlight and facilitate the visualization thereof, the ternary matrix of the molecular element or characteristic will appear in the consensus exons of panel 3.

Thus, when it is found, in the ternary matrix, “0” or any other specified character to designate the absence of an exon, in the molecular element or characteristic in question, aligned with the established consensus exon, the latter will be preferably displayed in grey color. When there is present in the matrix, for example, 1 or any other specified character to designate the presence of an exon, in the molecular element or characteristic in question, aligned with the established consensus exon, the latter will be preferably displayed in black The binary data will appear highlighted, preferably in white, within the consensus exons.

Table 16 exemplarily shows that, upon pressing the right button of the mouse or similar device over the identifier CN277391 (lower arrow), there is a change of its background color, preferably to yellow, and furthermore the ternary matrix is drawn over the consensus exons of panel 3 (upper arrow).

One other characteristic of the present invention consists in the opening of an additional panel for each molecular element or characteristic, upon the click of the right button of the mouse or similar device over the said element or characteristic. In this panel, the mapping information found in the raw data files is presented.

In Table 17, it is shown, as an example, that upon clicking over the second exon of the identifier CN277391 (upper arrow), the background color thereof changes, preferably to the yellow color, and an additional window (panel) containing the mapping coordinates information is also opened. The coordinates of the selected exon will preferably appear in red color (lower arrow). Thus, the mapping coordinates of an exon of interest are easily viewed.

In order that this additional information cease to be displayed, the end user should click with any of the buttons of the mouse or similar device over the additional panel having been opened.

Table 8 presents, as an example, in the viewer, the gene symbol APOE. The arrow at the upper corner of the screen shows that the consensus exons do not evidence any ternary matrix information if there was not made any selection of a molecular element or of a molecular characteristic. There is thus a regeneration of the consensus exon without the ternary matrix.

TABLE 16

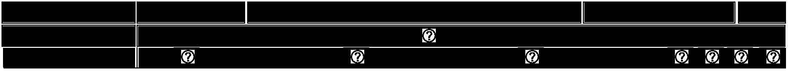

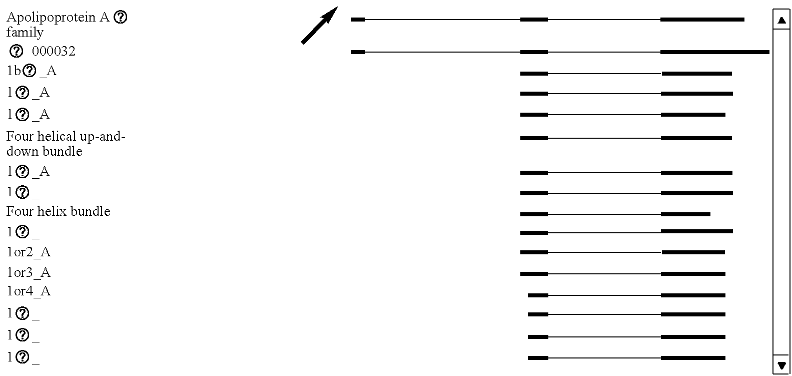

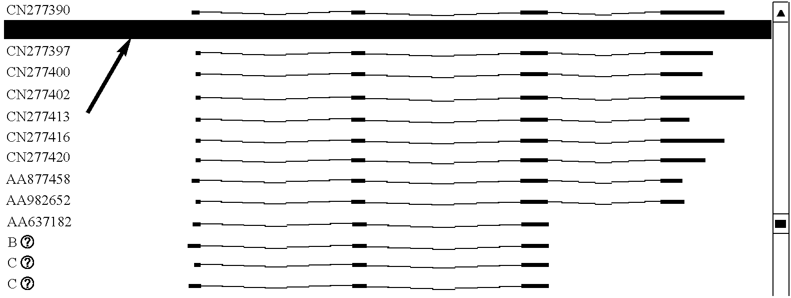

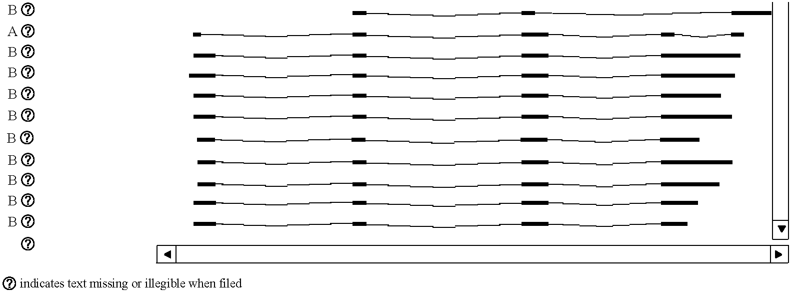

TABLE 17

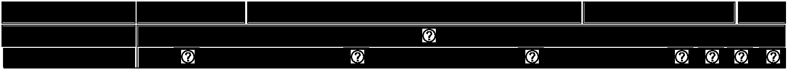

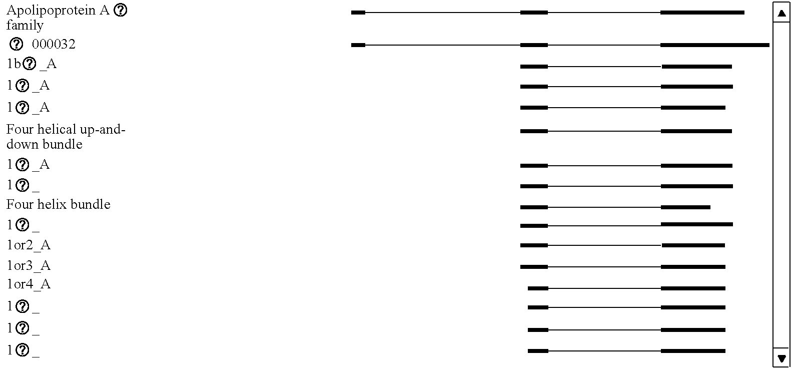

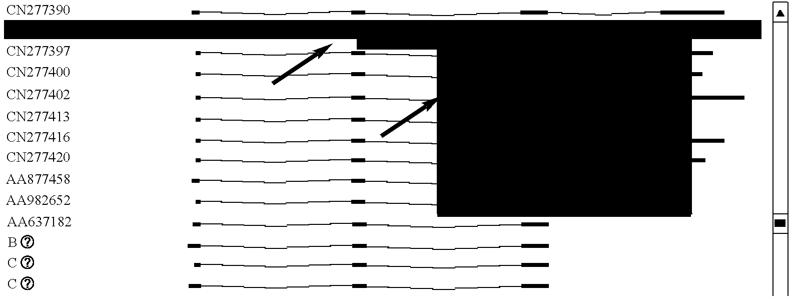

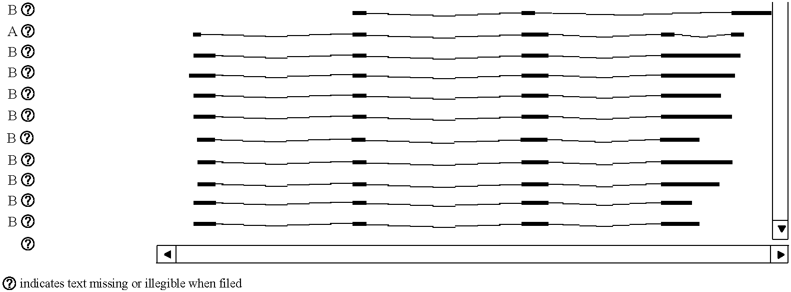

TABLE 18

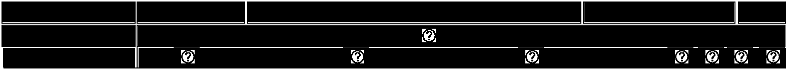

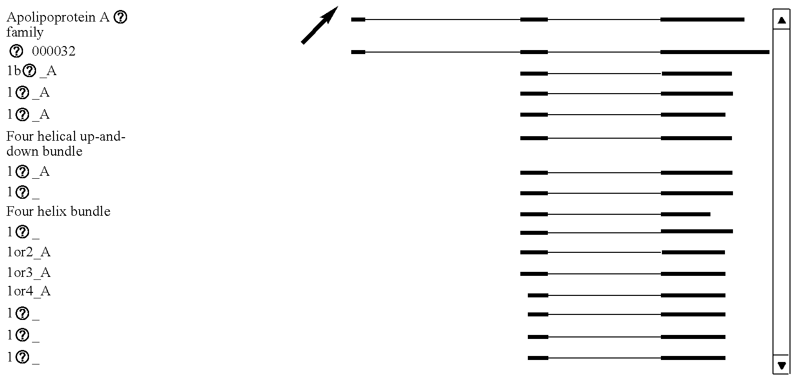

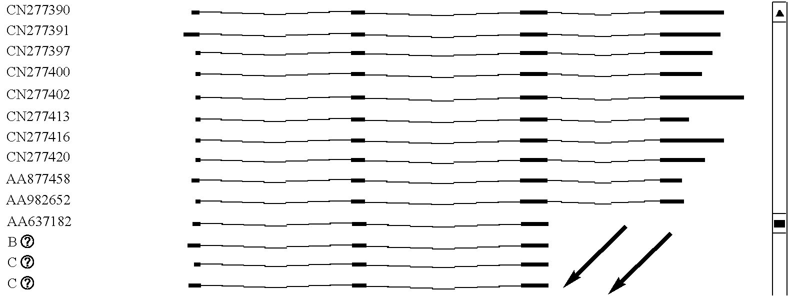

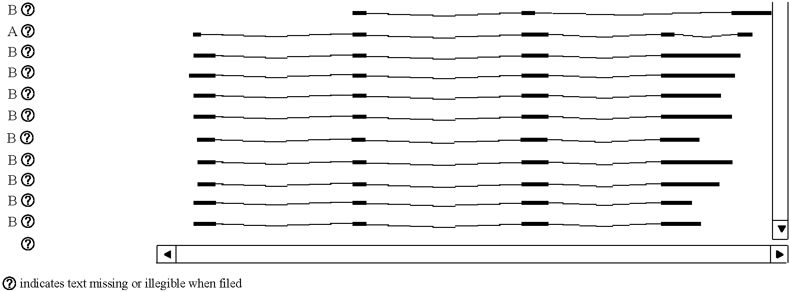

Furthermore, as cited previously in the instant specification, there is a possibility of observation of splicing variants by intercalating the background color, preferably between white and grey, in panel 5, relative to transcriptional data. The arrows present at the lower left hand and lower right hand corners of Table 18 show, as an example, the intercalation of the background color between splicing variants.

In light of everything that has been set forth above, one other unprecedented aspect of the present invention over the prior art resides in the fact that none of the portals cited in Table 1 carries easily viewable structural protein data as does the viewer according to the present invention. In the viewer of the Applicant, it is possible to rapidly ascertain whether a given gene has a homologous protein with a three-dimensional structure resolved experimentally and the degree of identity among the same. In case of structural aspects, the viewer according to the present invention constitutes the only database that shows structural domains referenced to the genome. This differential characteristic may have great impact in large-scale studies of structural genome projects, since that regions with annotated functional domains can be targeted for characterization of new structural domains.

Finally, it should be pointed out that the examples provided in the instant specification are merely intended to illustrate the present invention and should not be construed as limiting the scope thereof. Furthermore, the colors cited in the instant specification merely correspond to preferred embodiments of the invention, and should not be construed as limiting the scope thereof.

### REFERENCES

1. Brentani, H. et al. The generation and utilization of a cancer-oriented representation of the human transcriptome by using expressed sequence tags. Proc Natl Acad Sci USA, v. 100, n. 23, p. 13418-23, 2003.
2. Hsu, F.; Pringle, T. H.; Kuhn, R. M.; Karolchik D.; Diekhans, M.; Haussler, D.; Kent, W. J. The UCSC Proteome Browser. Nucleic Acids Res., v. 33, p. D454-D458, 2005.
3. Karolchik, D.; Baertsch, R.; Diekhans, M.; Furey, T. S.; Hinrichs, A.; Lu, Y. T.; Roskin, K. M.; Schwartz, M.; Sugnet, W.; Thomas, D. J.; Weber, R. J.; Haussler, D.; Kent, W. J. The UCSC Genome Browser database. Nucleic Acids Res., v. 31, n. 1, p. 51-54, 2003.
4. Kersey, P.; Bower, L.; Morris, L.; Horne, A.; Petryszak, R.; Kanz, C.; Kanapin, A.; Das, U.; Michoud, K.; Phan, I.; Gattiker, A.; Kulikova, T.; Faruque, N.; Duggan, K.; Mclaren, P.; Reimholz, B. Duret, L.; Penel, S.; Reuter, I.; Apweiler, R. Integr8 and Genome Reviews: integrated views of complete genomes and proteomes. Nucleic Acids Res., v. 33, p. D297-D302, 2005.
5. Kirschbaum-Slager, N.; Parmigiani, R. B.; Camargo, A. A.; de Souza, S. J. Identification of human exons overexpressed in tumors through the use of genome and expressed sequence data. Physiol Genomics, v. 21, n. 3, p. 423-32, 2005.
6. Maglott, D.; Ostell, J.; Pruitt, K. D.; Tatusova, T. Entrez Gene: gene-centered information at NCBI. Nucleic Acids Res., v. 33, p. D54-D58, 2005.
7. Nagasaki, H.; Arita, M.; Nishizawa, T.; Suwa, M.; Gotoh, O. Species-specific variation of alternative splicing and transcriptional initiation in six eukatyotes. Gene, v. 364, p. 53-62, 2005.
8. Passetti, F. Diversidade na arquitetura e expressão gênica: uma análise quantitativa de exon shuffling e splicing alternativo. [Diversity in architecture and gene expression: a quantitative analysis of exon shuffling and alternative splicing] São Paulo, 2002. 120p. Dissertação (Mestrado em Bioquímica) [Master's dissertation—Biochemistry]—Instituto de Química, Universidade de São Paulo [Chemistry Institute, University of São Paulo].
9. Pruitt, K. D.; Tatusova, T.; Maglott, D. R. NCBI Reference Sequence. (RefSeq): a curated non-redundant sequence database of genomes, transcripts and proteins. Nucleic Acids Res., v. 33, p. D501-D504, 2005.
10. Sakabe, N. J.; de Souza, J. E. S.; Galante, P. A. F.; de Oliveira, P. S. L.; Passetti, F.; Brentani, H.; Osório, E. C.; Zaiats, A. C.; Leerkes, M. R.; Kitajima, J. P.; Brentani, R. R.; Strausberg, R. L.; Simpson, A. J. G.; de Souza, S. J. ORESTES [Open Reading Frames EST Sequences] are enriched in rare exon usage variants affecting the encoded proteins. C. R. Biologies, v. 326, n. 10-11, p. 979-85, 2003.

1. An use of a ternary matrix as a molecular biological information adapter, characterized by being intended to integrate the said biological information, and the said matrix having a size N×M, wherein
N is the number of rows relative to the various molecular elements or characteristics mapped in a given region of sequenced DNA, and
M is the number of columns, relative to all consensus exons and consensus introns of a given gene, where each column is attributed a character X, in case of presence, or Y, in case of absence, in a given molecular element or characteristic, of a sequence relative to a biological information of interest aligned with the established consensus exon, or Z to indicate the beginning and the end of a given exon relative to a given molecular element or characteristic, where X, Y and Z are different from one another.

2. the use, according to claim 1, characterized in that X is “1”, Y is “0”, and Z is any character, provided that it is other than “1” and “0”.

3. The use, according to claim 1, characterized in that a sequence relative to a given biological information in a given molecular element or characteristic partially aligned with the established consensus exon is sufficient to determine its presence in the data adaptation.

4. The use, according to claim 1, characterized in that the delimiting character is a symbol “|”.

5. The use, according to claim 1, characterized in that one said molecular element comprises a sequence of DNA, RNA or polypeptide chain determined experimentally or by prediction.

6. The use, according to claim 1, characterized in that one said molecular characteristic comprises any characteristic or property of physical, chemical or biological nature that a molecular element has or that may have been predicted.

7. The use, according to claim 1, characterized by being intended for identification of molecular candidates for diagnosis and prognosis of pathologies.

8. A method of searching and viewing molecular biological information stored in at least one database, characterized by comprising the steps of:
(i) displaying to the user a field for inputting the biological information to be searched;
(ii) input by the user, in the field displayed in step (i), of the biological information to be searched;
(iii) reading of the biological information integrated in a ternary matrix as defined in claim 1 and of the supplementary biological information, in accordance with the search requested in step (ii);
(iv) generation of text and graphic representations of the information read in step (iii), where the graphic representations may have distinct colors in order to evidence the source of each biological information;
(v) generation of a plurality of panels containing the representations generated in step (iv), wherein the panels may have the same horizontal scale that is based on the transformation of genomic coordinates of the biological elements according to the screen wherein the panels will be displayed;
(vi) displaying to a user, on the screen of a display device, the plurality of panels generated in step (v).

9. The method according to claim 8, characterized in that the display device is a computer monitor.

10. The method, according to claim 8, characterized in that at least one of the panels generated in step (v) represents small molecular characteristics.

11. The method according to claim 8, characterized in that at least one of the panels generated in step (v) represents the exon consensus.

12. The method according to claim 8, characterized in that at least one of the panels generated in step (v) represents protein.

13. The method according to claim 8,
characterized in that at least one of the panels generated in step (v) represents transcripts.

14. The method according to claim 8, characterized in that the panels are displayed in alignment with one another.

15. The method according to claim 8, characterized in that the heights of the panels are adjusted automatically according to the amount of information to be displayed.

16. The method according to claim 8, characterized in that the heights and/or widths of the panels are adjusted by the user for purposes of improvement of viewing comfort.

17. The method according to claim 8, characterized by additionally comprising, prior to step (i), the step of display of a field for inputting the user identification, in order to access to the user if the same is registered at the database.

18. The method according to claim 17, characterized by additionally comprising the display of a field for inputting the user's security password, to enable access to the user if the password typed thereby coincides with that which is stored in the database.

19. The method according to claim 8, characterized in that the graphic representation of the biological elements displayed in at least one of the panels includes graphic elements that identify the initial and final genome coordinates of the biological element that constitutes the object of the search.

20. The method according to claim 8, characterized by additionally comprising, after step (vi), the step of interaction of the user with the information displayed on the screen.

21. The method according to claim 20, characterized in that the interaction is through the use of a computer mouse or similar device.

22. The method according to claim 20, characterized in that the user, upon selecting regions of the elements displayed in the panels, is able to view the biological information integrated in the matrix and the supplementary biological information read in step (iii).

23. The method according to claim 22, characterized in that the visualization of the biological information is provided by means of a window displayed on the screen of the display device.

24. The method according to claim 8, characterized by being preferentially implemented by means of a computer program.

25. The method according to claim 8, characterized in that the method is accessed by the user via the Internet and/or a local computer network.
